(19) United States
(12) Patent Application Publication
(10) Pub. No.: US 2022/0064058 A1
(43) Pub. Date: Mar. 3, 2022

(54) Glass Substrate Multilayer Structure, Method of Producing the Same, and Flexible Display Panel Including the Same

(71) Applicants: SK Innovation Co., Ltd., Seoul (KR); SK ie technology Co., Ltd., Seoul (KR)

(72) Inventor: Cheol Min Yun, Daejeon (KR)

(21) Appl. No.: 17/463,702

(22) Filed: Sep. 1, 2021

(30) Foreign Application Priority Data
Sep. 3, 2020 (KR) 10-2020-0112018

(51) Int. Cl. C03C 17/32; G09F 9/30

(52) U.S. Cl. CPC C03C 17/32; C03C 2217/78; G09F 9/301

(57) ABSTRACT

Provided are a glass multilayer structure, a method of producing the same, and a flexible display panel including the same. Specifically, a glass substrate multilayer structure including a flexible glass substrate and a polyimide-based shatterproof layer formed on one surface of the flexible glass substrate, and a flexible display panel including the same are provided.

### CROSS-REFERENCE TO RELATED APPLICATION

This application claims priority to Korean Patent Application No. 10-2020-0112018 filed Sep. 3, 2020, the disclosure of which is hereby incorporated by reference in its entirety.

### BACKGROUND OF THE INVENTION

### Field of the Invention

The following disclosure relates to a glass substrate multilayer structure, a method of producing the same, and a flexible display panel including the same.

### Description of Related Art

In recent years, thinner display devices are required with the development of mobile devices such as smart phones and tablet PCs, and among them, a flexible display device which may be curved or foldable when a user wants or a flexible display device of which the manufacturing process includes curving or folding is receiving attention.

The display device includes a transparent window covering a display screen, and the window has a function of protecting the display device from external impact, scratches applied during the use, and the like.

Glass or tempered glass which is a material having excellent mechanical properties is generally used for a window for displays, but glass has no flexibility and results in a higher weight of a display device due to its weight.

In order to solve the problem described above, a technology to thin a flexible glass substrate has been developed, but is not sufficient for implementing flexible properties capable of being curved or bent and currently has yet to solve the problem of being easily broken by an external impact. In particular, in the case of a flexible display device, a glass substrate window is easily broken by external impact or in the process of curving or folding and the fragments shatter to cause a user to be injured.

In order to solve the above, efforts were made to solve the problems by forming a shatterproof layer on a flexible glass thin film, but the shatterproof layer is generally formed by an acrylic resin adhesive or the adhesive is interposed to form the shatterproof layer, and thus, shatter resistant properties and impact resistance are not sufficient and costs are increased with increased process steps, and thereafter, it is difficult to remove an acrylic adhesive in reproduction of a glass substrate.

In addition, a conventional shatterproof layer including the acrylic shatterproof layer still has problems of an occurrence of pen marks due to pen drop on the shatterproof layer in a pen drop test, lack of adhesiveness, and lack of bending properties. In order to solve the above, when a surface hardness was increased by the shatterproof layer, the glass substrate multilayer structure may not be sufficiently curved or folded.

Accordingly, the development of a novel flexible glass substrate multilayer structure, which has excellent flexibility such as being hardly cracked in thousands of folding and unfolding, has further improved durability such as impact resistance and shatter resistance, has excellent thermal resistance and optical properties, has an effect of no pen drop mark in the pen drop test, as an example, even when a pen was dropped from a height of 10 cm, 20 cm, or 25 cm, has a bending value within ±0.2 mm or within ±0.15 mm, provides excellent physical properties in adhesiveness with glass, reduces manufacturing costs by simplification of a process, and allows easy reproduction, is currently needed.

### SUMMARY OF THE INVENTION

An embodiment of the present invention may be realized by providing a glass substrate multilayer structure capable of being applied to a flexible display device, which has excellent durability and shatter resistant properties to secure a user's safety.

Another embodiment of the present invention may be realized by providing a glass substrate multilayer structure capable of being applied to a flexible display device, which has excellent surface properties so that no pen mark occurs even when a pen is dropped from a high height and also flexible properties to allow being curved or bent, so that glass is not broken or not cracked even when repeating curving or folding.

Another embodiment of the present invention may be realized by providing an excellent glass substrate multilayer structure which has further improved surface hardness, shatter resistance, and flexibility as compared with a conventional art and has no pen mark in the pen drop test, since a shatterproof layer formed of a polyimide-based resin, in particular, a polyimide-based resin containing a fluorine element, is formed on a flexible glass substrate.

Another embodiment of the present invention may be realized by providing a flexible glass substrate multilayer structure which has a value within ±0.2 mm or within ±0.15 mm in bending properties and provides excellent physical properties in adhesiveness with glass.

Still another embodiment of the present invention is a glass substrate multilayer structure which has lower manufacturing costs and may be easily reproduced after its use.

In one general aspect, a glass substrate multilayer structure includes a flexible glass substrate; and a polyimide-based shatterproof layer formed on one surface of the flexible glass substrate.

In an exemplary embodiment of the present invention, the polyimide-based shatterproof layers may be formed of a polyimide-based resin including a unit derived from a fluorine-based aromatic diamine and a unit derived from an aromatic dianhydride.

In an exemplary embodiment of the present invention, the flexible glass substrate may have a thickness of 1 to 100 μm.

In an exemplary embodiment of the present invention, the polyimide-based shatterproof layer may have a thickness of 100 nm to 10 μm.

In an exemplary embodiment of the present invention, the glass substrate multilayer structure may have a pencil hardness of 4H to 6H in accordance with ASTM D3363.

In an exemplary embodiment of the present invention, the glass substrate multilayer structure may have an impact resistance of 20 cm or more by a pen drop test.

In an exemplary embodiment of the present invention, the glass substrate multilayer structure may have a value within ±0.2 mm in bending properties as measured after a shatterproof layer and a hard coating layer are formed on a glass substrate having a width of 180 mm×a length of 76 mm×a thickness of 40 μm and then immediately the glass substrate multilayer structure is placed on a leveled vibration isolation table, and adhesion of 5B in accordance with ASTM D3359.

In another general aspect, a method of producing a glass substrate multilayer structure includes: applying a shatterproof composition on a rear surface of a flexible glass substrate and curing the shatterproof composition to form a polyimide-based shatterproof layer.

In an exemplary embodiment of the present invention, the shatterproof composition may include a fluorine-based aromatic diamine and an aromatic dianhydride.

In still another general aspect, a flexible display includes the glass substrate multilayer structure.

Other features and aspects will be apparent from the following detailed description, the drawings, and the claims.

### BRIEF DESCRIPTION OF THE DRAWING

FIG. 1 is an exploded perspective view which schematically shows a cross-section of a glass substrate multilayer structure according to an exemplary embodiment of the present invention.

### DETAILED DESCRIPTION OF MAIN ELEMENTS

10: flexible glass substrate

20: polyimide-based shatterproof layer

100: glass substrate multilayer structure

### DESCRIPTION OF THE INVENTION

The terms used in the present disclosure have the same meanings as those commonly understood by a person skilled in the art. In addition, the terms used herein are only for effectively describing a certain specific example, and are not intended to limit the present disclosure.

The singular form used in the specification of the present disclosure and the claims appended thereto may be intended to also include a plural form, unless otherwise indicated in the context.

Throughout the present specification describing the present disclosure, unless explicitly described to the contrary, “comprising” any elements will be understood to imply further inclusion of other elements rather than the exclusion of any other elements.

The term “flexible” in the present disclosure refers to being curved, bent, or folded.

The term “shatterproof layer” in the present disclosure is used to refer to including a “polyimide-based shatterproof layer”.

The term “within” in the present disclosure is used to refer to an inclusion range, and as a specific example, “within ±0.2 mm” is used to refer to a range including +0.2 mm and −0.2 mm.

The inventors of the present disclosure conducted many studies to solve the above problems, and as a result, found a glass substrate multilayer structure which, by forming a polyimide-based shatterproof layer on one surface of a flexible glass substrate, has bending properties, adhesiveness, and excellent pen drop properties and also has excellent flexible properties while having significantly improved shatter resistance, impact resistance, and optical properties, and thus, is appropriate for being applied as a cover window of a flexible display panel, thereby completing the present disclosure.

In addition, the polyimide-based shatterproof layer is formed of a polyimide resin, in particular, a fluorine-containing polyimide resin, whereby the present disclosure shows a surprising effect of having excellent adherence with a flexible display device as compared with a conventional shatterproof layer formed of an acrylic resin or other resins and forming no pen mark when a pen is dropped from a high height in a pen drop test, without loss of curving or folding properties.

Hereinafter, each constituent of the present disclosure will be described in detail with reference to a drawing. However, these are only illustrative and the present disclosure is not limited to the specific embodiments which are illustratively described in the present disclosure.

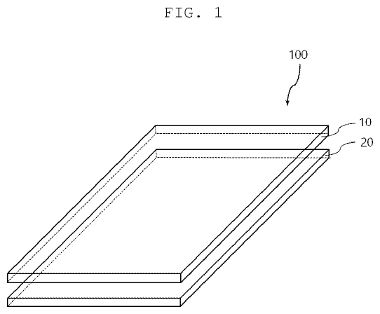

FIG. 1 is a schematic drawing illustrating a glass substrate multilayer structure according to an exemplary embodiment of the present invention. As seen in FIG. 1, the glass substrate multilayer structure 100 according to an exemplary embodiment of the present invention includes a polyimide-based shatterproof layer 20 formed on one surface of a flexible glass substrate 10.

The glass substrate multilayer structure according to an exemplary embodiment of the present invention may have a pencil hardness according to ASTM D3363 of 3H or more, specifically 4H or more, and the upper limit is not particularly limited, but may be 6H. In addition, an impact resistance may be 10 cm or more, specifically 20 cm or more, more specifically 25 cm or more, and still more specifically 30 cm or more, by a pen drop test. Here, the impact resistance properties by the pen drop test refer to a state in which there is no surface nicks or press when a ballpoint pen having a diameter of 0.7 mm and a weight of 5.3 g is vertically dropped.

The glass substrate multilayer structure according to an exemplary embodiment of the present invention may have a value within ±0.2 mm or within ±0.15 mm in bending properties as measured after a shatterproof layer and a hard coating layer are formed on a glass substrate having a width of 180 mm×a length of 76 mm×a thickness of 40 μm and then immediately the glass substrate multilayer structure is placed on a leveled vibration isolation table, and adhesion of 5B in accordance with ASTM D3359.

When glass substrate multilayer structure according to an exemplary embodiment of the present invention is produced as a polyimide film forming a polyimide-based shatterproof layer, the glass substrate multilayer structure has a modulus in accordance with ASTM E1111 of 5 GPa or less, 3 GPa or less, or 2.5 GPa or less, an elongation at break of 10% or more, 20% or more, or 30% or more, a light transmittance at 388 nm of 5% or more or 5 to 80% and a light transmittance at 400 to 700 nm of 87% or more, 88% or more, or 89% or more, as measured in accordance with ASTM D1746, a haze in accordance with ASTM D1003 of 2.0% or less, 1.5% or less, or 1.0% or less, a yellow index in accordance with ASTM E313 of 5.0 or less, 3.0 or less, or 0.4 to 3.0, and a b* value of 2.0 or less, 1.3 or less, or 0.4 to 1.3.

The glass substrate multilayer structure according to an exemplary embodiment of the present invention adopts a polyimide containing a fluorine element as a shatterproof layer forming material to form a polyimide-based shatterproof layer on one surface of a flexible glass substrate, thereby providing excellent surface properties in which no pen mark is formed even from a high height in a pen drop test without damaging excellent bending properties or folding characteristic of a glass substrate. In addition, the glass substrate multilayer structure easily implements flexible properties with excellent flexibility and has excellent impact resistance and shatter resistant properties, thereby securing user's safety, and is transparent with excellent optical properties to be applied as a window cover of a flexible display panel.

Furthermore, when a flexible display device is formed on the polyimide-based shatterproof layer of the glass substrate multilayer structure according to an exemplary embodiment of the present invention, adhesive strength with the device is excellent, and when defective products occur due to an error in a process, easy removal is possible, thereby having excellent reprocessability.

Hereinafter, referring to FIG. 1, a flexible glass substrate 10 and a polyimide-based shatterproof layer 20 formed on one surface of the flexible glass substrate 10 forming the glass substrate multilayer structure 100 according to an exemplary embodiment of the present invention will be described in more detail.

<Flexible Glass Substrate>

A flexible glass substrate refers to a foldable or curved glass substrate, may function as a window of a display device, and has good durability and excellent surface smoothness and transparency.

In an exemplary embodiment of the present invention, the flexible glass substrate is not limited as long as it contains glass, but specifically, may be selected from common glass, soda lime glass, tempered glass, and the like.

In an exemplary embodiment of the present invention, a glass substrate multilayer structure 100 may be formed on one surface of a flexible display panel 100 or may be curved or folded in response to curving or folding. Here, in order for the glass substrate multilayer structure 100 to be deformed so as to be bent with a relatively small radius of curvature or be roughly folded, a flexible glass substrate 10 should be formed of an ultra-thin glass substrate. In an exemplary embodiment of the present invention, the flexible glass substrate 10 may be an ultra-thin glass substrate, and may have a thickness of 100 μm or less, specifically 1 to 100 μm or 30 to 100 μm.

In an exemplary embodiment of the present invention, the flexible glass substrate may further include a chemical reinforcement layer, and the chemical reinforcement layer may be formed by performing a chemical reinforcement treatment on any one or more surfaces of a first surface and a second surface of a glass substrate included in the flexible glass substrate, thereby improving the strength of the flexible glass substrate.

There are various methods of forming a chemical reinforcement-treated ultra-thin flexible glass substrate as such, and as an example, a method of preparing an original long glass having a thickness of 100 μm or less, processing the glass into a predetermined shape by cutting, chamfering, sintering, and the like, and subjecting the processed glass to a chemical reinforcement treatment may be included. As another example, an original long glass having a normal thickness is prepared and slimmed into a thickness of 100 μm or less, and then may be subjected to shape processing and a chemical reinforcement treatment sequentially. Here, slimming may be performed by any one selected from a mechanical method and a chemical method or both in combination.

<Polyimide-Based Shatterproof Layer>

A polyimide-based shatterproof layer in the present disclosure should be a layer of adsorbing energy generated in breakage of the glass substrate 10 to prevent fragments of the glass substrate 10 from shattering and also a layer imparting excellent surface properties of causing no damage due to external impact. For example, the polyimide-based shatterproof layer should provide excellent surface properties of forming no pen mark in a pen drop test carrying out from a height of 10 cm, 20 cm, or 30 cm or more.

Furthermore, the polyimide-based shatterproof layer of the present disclosure may further impart the surface properties better by forming a polyimide, in particular, a polyimide containing a fluorine element as a shatterproof layer, has excellent adherence with a flexible display device formed on the shatterproof layer, and has ease of removal as compared with a conventional shatterproof layer formed of an acrylic resin.

In an exemplary embodiment of the present invention, the polyimide-based shatterproof layer may be formed of a polyimide-based resin including a unit derived from an aromatic diamine and a unit derived from an aromatic dianhydride known in the art. In particular, as an exemplary embodiment of the present invention, the polyimide-based shatterproof layer is formed of a polyimide-based resin including a unit derived from a fluorine-based aromatic diamine and a unit derived from an aromatic dianhydride, specifically, a polyimide resin obtained by polymerizing a monomer including the fluorine-based aromatic diamine and the aromatic dianhydride, and has excellent optical physical properties and mechanical physical properties, and excellent elasticity and restoration force.

In an exemplary embodiment of the present invention, as the fluorine-based aromatic diamine, any one or two or more selected from 1,4-bis(4-amino-2-trifluoromethylphenoxy)benzene (6FAPB), 2,2′-bis(trifluoromethyl)benzidine (TFMB), 2,2′-bis(trifluoromethyl)-4,4′-diaminodiphenyl ether (6FODA), and the like may be used. In addition, the fluorine-based aromatic diamine may be used in combination with other known aromatic diamine components, but the present disclosure is not limited thereto. By using the fluorine-based aromatic diamine as such, the shatter resistant properties of the polyimide-based shatterproof layer produced may be further improved, the optical properties thereof may be further improved, and the yellow index thereof may be also improved.

In an exemplary embodiment of the present invention, the aromatic dianhydride may be any one or two or more selected from 4,4′-hexafluoroisopropylidene diphthalic anhydride (6FDA), biphenyltetracarboxylic dianhydride (BPDA), oxydiphthalic dianhydride (ODPA), sulfonyl diphthalic anhydride (SO2DPA), (isopropylidenediphenoxy) bis(phthalic anhydride) (6HDBA), 4-(2,5-dioxotetrahydrofuran-3-yl)-1,2,3,4-tetrahydronaphthalene-1,2-dicarboxylic dianhydride (TDA), 1,2,4,5-benzene tetracarboxylic dianhydride (PMDA), benzophenone tetracarboxylic dianhydride (BTDA), bis(carboxylphenyl) dimethyl silane dianhydride (SiDA), bis(dicarboxyphenoxy) diphenyl sulfide dianhydride (BDSDA), ethylene glycol bis(anhydrotrimellitate (TMEG100), and the like, but is not limited thereto.

In an exemplary embodiment of the present invention, the fluorine-based aromatic diamine and the aromatic dianhydride may be used at a mole ratio of 1.5:1 to 1:1.5, specifically 1.3:1 to 1:1.3, or 1.2:1 to 1:1.2, but is not limited thereto.

In an exemplary embodiment of the present invention, the polyimide-based shatterproof layer may have a thickness of 10 μm or less or 8 μm or less, and the lower limit is not particularly limited, but may be 10 nm.

<Flexible Display Panel>

In an exemplary embodiment of the present invention, a flexible display panel or a flexible display device including the glass substrate multilayer structure according to the exemplary embodiment as a window cover may be provided.

In an exemplary embodiment of the present invention, a glass substrate multilayer structure 100 in the flexible display device may be used as an outermost surface window substrate of the flexible display panel. As a specific exemplary embodiment, the flexible display panel may have a structure in which a flexible display device is formed on the polyimide-based shatterproof layer 20 of the glass substrate multilayer structure 100 of the present disclosure. When the flexible display panel has a multilayer structure as such, adhesive strength between the glass substrate multilayer structure 100 and the flexible display device is better, shattering is prevented when the flexible glass substrate 10 is damaged, and the flexible display device is protected.

The flexible display device may be various image display devices such as a common liquid crystal display device, an electroluminescent display device, a plasma display device, and a field emission display device.

<Method of Producing Glass Substrate Multilayer Structure>

Hereinafter, a method of producing a glass substrate multilayer structure according to an exemplary embodiment of the present invention will be described in detail.

The method of producing a glass substrate multilayer structure according to an exemplary embodiment of the present invention may include: applying a shatterproof composition on one surface of a glass substrate and curing the shatterproof composition to form a polyimide-based shatterproof layer.

First, a shatterproof composition in forming the polyimide-based shatterproof layer will be described.

In an exemplary embodiment of the present invention, the shatterproof composition may include a fluorine-based aromatic diamine and an aromatic dianhydride, and the fluorine-based aromatic diamine and the aromatic dianhydride may be the same as those described above. As a specific exemplary embodiment, the shatterproof composition may be a polyimide precursor prepared by dissolving the fluorine-based aromatic diamine in an organic solvent to obtain a mixed solution, to which the aromatic dianhydride is added to perform a polymerization reaction. Here, the reaction may be carried out under an inert gas or a nitrogen stream, or under anhydrous conditions. In addition, the temperature during the polymerization reaction may be −20° C. to 200° C. or 0° C. to 180° C., and the organic solvent which may be used in the polymerization reaction may be selected from N,N-diethylacetamide (DEAc), N,N-diethylformamide (DEF), N-ethylpyrrolidone (NEP), dimethylpropaneamide (DMPA), diethylpropaneamide (DEPA), or a mixture thereof.

Here, the polyimide precursor solution may be in the form of a solution dissolved in an organic solvent or may be a dilution of the solution in other solvents. In addition, when the polyimide precursor is obtained as a solid powder, this may be dissolved in an organic solvent to form a solution.

Thereafter, the polyimide precursor may be imidized, thereby preparing a polyimide solution (shatterproof composition). Here, as the imidization process, a known imidization method may be used without limitation, but a specific example includes a chemical imidization method, a thermal imidization method, and the like, and as an exemplary embodiment of the present invention, specifically, an azeotropic thermal imidization method may be used.

In the azeotropic thermal imidization method, toluene or xylene is added to a polyimide precursor (polyamic acid solution) and stirring is carried out to perform an imidization reaction at 160° C. to 200° C. for 6 to 24 hours, during which water released while an imide ring is produced may be separated as an azeotropic mixture of toluene or xylene.

The polyimide solution prepared according to the above preparation method may include a solid content in an amount to have an appropriate viscosity, considering processability such as coatability.

According to an exemplary embodiment, the shatterproof composition (polyimide solution) may have a solid content of 1 to 30 wt %, specifically 5 to 25 wt %, or 8 to 20 wt %.

Hereinafter, a method of forming a polyimide-based shatterproof layer will be described.

In an exemplary embodiment of the present invention, the polyimide-based shatterproof layer may be formed by applying the shatterproof composition on one surface of the flexible glass substrate and curing the shatterproof composition. Here, the application method is not limited, but various methods such as bar coating, dip coating, die coating, gravure coating, comma coating, slit coating, or a combined method thereof may be used.

The curing may be a heat treatment at a temperature of 40° C. to 250° C., the number of heat treatments may be one or more, and the heat treatment may be performed once or more at the same temperature or in different temperature ranges. In addition, the heat treatment time may be 1 minute to 60 minutes, but is not limited thereto.

In addition, the polyimide-based shatterproof layer may be formed of one or more layers, but is not limited thereto.

Hereinafter, the present disclosure will be described in more detail with reference to the Examples and Comparative Examples. However, the following Examples and Comparative Examples are only an example for describing the present disclosure in more detail, and do not limit the present disclosure in any way.

Hereinafter, the physical properties were measured as follows:

1) Pencil Hardness

A pencil hardness on a surface of a glass substrate multilayer structure produced in the Examples and the Comparative Examples was measured using pencils by hardness (Mitsubishi Pencil Co., Ltd.) under a load of 1 kg using a pencil hardness tester (Kipae E&T Co. Ltd.), in accordance with ASTM D3363. The surface refers to an opposite surface to the surface on which a shatterproof layer was formed.

2) Evaluation of Impact Resistance Properties (Pen Drop Test)

On glass substrate multilayer structure samples produced in the following Examples and Comparative Examples, a 0.7 mm BIC

Orange pen of (5.3 g) was vertically stood and dropped to a designated position, and the state of the substrate was evaluated based on the following criteria:

<Evaluation Criteria>

⊚: no nicks and pressing

∘: nicks and pressing present

×: Broken (not shattered)

▴: different results in two evaluations

3) Adhesion

Adhesion was measured by the method of ASTM D3359. Adhesion between a polyimide-based shatterproof layer and a glass substrate was measured. Checkered grooves were made in a coating film by a cutter and the coating film was soaked in a hot bath at 80° C. for 5 hours, moisture on the surface was wiped, a 3M tape was closely adhered thereon well and then detached several times with constant force, and an adhesion degree between a coating layer and a substrate was observed. 11×11 crosswise cuts were made at 1 mm intervals on the surface of a coated support to make 100 squares, and a tape (3M tape) was adhered thereon and then rapidly pulled to evaluate the surface. The number of remaining squares of 100 was represented as 5B, 95 or more was represented as 4B, 85 or more was represented as 3B, 65 or more was represented as 2B, 35 or more was represented as 1B, and less than 35 was represented as 0B.

4) Bending Properties

The glass substrate multilayer structures produced in the following Examples and Comparative Examples were placed on a flat ground and a degree to which the glass substrate multilayer structure was bent upward or downward was measured, and when the edge portions of the glass substrate were bent upward, the value was represented as +, and when the portions were bent or curved downward, the value was represented as −.

Specifically, on a glass substrate having a width of 180 mm×a length of 76 mm×a thickness of 40 μm, each shatterproof layer and hard coating layer forming composition was applied and cured, and immediately after that, the glass substrate multilayer structure was placed on a correctly leveled vibration isolation table, and the bending of the glass substrate multilayer structure was measured at room temperature. Here, when the glass substrate multilayer structure was curved in a direction of the vibration isolation table and a center of the glass substrate was curved to an air layer, a step difference from the highest curve point portion of the center was measured based on the edge and shown as a negative (stress) value (mm), and conversely, when the both ends (edges) of the glass substrate were curved in a direction of the air layer on the vibration isolation table, a step difference of a raised edge was measured based on the center and shown as a positive (tension) value (mm).

### PREPARATION EXAMPLE 1

Preparation of fluorine element-containing polyimide-based shatterproof layer forming composition

An agitator in which a nitrogen stream flowed was filled with 153 g of (N,N-dimethylpropionamide (DMPA), and 41 g of 2,2′-bis(trifluoromethyl)-4,4′-diaminodiphenyl ether (6FODA) was dissolved therein while the temperature of a reactor was maintained at 25° C. 50 g of ethylene glycol bis(anhydrotrimellitate) (TMEG100) was added to the 6FODA solution at the same temperature, and dissolved therein with stirring for a certain period of time. 70 g of toluene was added to a polyimide precursor solution prepared from the above reaction, a reflux was performed at 180° C. for 6 hours to remove water, and dimethylpropaneamide (DMPA) was added so that a solid content concentration was 20 wt % to prepare a shatterproof layer forming composition (polyimide solution).

### PREPARATION EXAMPLE 2

Preparation of Urethaneacrylic Shatterproof Layer Forming Composition

60 g of urethane acrylate (UV-6100B, “Nippon Gosei” product available from Nippon Gosei Kagakusha K.K.), 20 g of 2-hydroxypropyl acrylate (“Light Ester HOP-A” available from Kyoeisha Kagakusha K.K.), 20 g of 1,6-hexanediol diacrylate (HDODA, available from Dial UCB Co.), and 1 g of Darocure 1174 (trade name, available from Ciba-Geigy Co.) as an initiator were uniformly mixed to prepare a shatterproof layer forming composition.

### EXAMPLE 1

The shatterproof layer forming composition prepared in Preparation Example 1 was applied on one surface of a glass substrate (UTG 40 μm) with a #20 mayer bar, dried at 50° C. for 1 minute, and dried at 230° C. for 10 minutes to form a polyimide-based shatterproof layer having a thickness of 3 μm.

### EXAMPLE 2

A glass substrate multilayer structure was produced in the same manner as in Example 1 except that the thickness of the polyimide-based shatterproof layer was formed at 5 μm.

### EXAMPLE 3

A glass substrate multilayer structure was produced in the same manner as in Example 1 except that the thickness of the polyimide-based shatterproof layer was formed at 10 μm.

### COMPARATIVE EXAMPLE 1

A glass substrate multilayer structure was produced in the same manner as in Example 1, except that a shatterproof layer was formed by using the shatterproof forming composition of Preparation Example 2 and irradiating an ultraviolet ray at 360 nm at an irradiation intensity of 30 mW/cm².

The physical properties of the glass substrate multilayer structures produced in Examples 1 to 3 and Comparative Example 1 were measured and are shown in the following Table 1.

TABLE 1

| | | | | | Impact resistance | | | Bending |
|---|---|---|---|---|---|---|---|---|
| | | | Shatterproof | Surface | properties | | | properties |
| | | | layer | hardness | (result/height) | | Adhesion | (unit: mm) |
| Example | 1 | Thickness | 3 | 5H | ⊚/20 | cm | 5B | −0.15 |
| | | (μm) | | | | | | |
| | | Composition | Preparation | | | | | |
| | | | Example 1 | | | | | |
| | 2 | Thickness | 5 | 5H | ⊚/25 | cm | 5B | −0.18 |
| | | (μm) | | | | | | |
| | | Composition | Preparation | | | | | |
| | | | Example 1 | | | | | |
| | 3 | Thickness | 10 | 4H | ⊚/15 | cm | 5B | 0.11 |
| | | (μm) | | | | | | |
| | | Composition | Preparation | | | | | |
| | | | Example 1 | | | | | |
| Comparative | 1 | Thickness | 5 | 2H | X/15 | cm | 1B | −1.5 |
| Example | | (μm) | | | | | | |
| | | Composition | Preparation | | | | | |
| | | | Example 2 | | | | | |

As seen in Table 1, it was found that Examples 1 to 3 had an excellent surface hardness of 4H or more, and also, had excellent shatter resistant properties, excellent impact resistance properties, and excellent adhesion even at a height of 15 cm or more.

However, it was confirmed that Comparative Example 1 had significantly poor surface hardness, impact resistance properties, and adhesion.

In addition, it was confirmed in Examples 1 to 3 that the glass substrate multilayer structure produced had a bending within ±0.15 mm with excellent bending properties. However, it was confirmed in Comparative Example 1 that a bending was 1.5 mm which was large.

The glass substrate multilayer structure of the present disclosure has a high surface hardness, is flexible, and has excellent thermal resistance and optical properties, and simultaneously, provides a surface on which it is difficult to form pen marks.

In addition, the glass substrate multilayer structure of the present disclosure adopts a polyimide-based shatterproof layer, in particular, a fluorine-containing polyimide, on one surface of a flexible glass substrate, thereby having significantly improved shatter resistance and impact resistance properties as compared with a conventional shatterproof layer formed of an acrylic resin, though it is a thin coating layer of 10 μm or less, and having excellent flexibility and excellent impact resistance properties, and thus, has an effect appropriate for a flexible display window. Specifically, since a shatterproof layer adopting a polyimide is formed on the rear surface of the glass substrate, adherence with a flexible display panel is excellent, and since a conventional acrylic shatterproof layer is formed in a manner of laminating a thick film by a lamination method, a surface hardness is decreased after lamination, however, though the multilayer structure of the present process is formed by coating with a small thickness by a method of coating a thin film, it may maintain surface hardness properties of the substrate itself while retaining shatter resistance and impact resistance properties.

Moreover, the glass substrate multilayer structure according to the present disclosure implements a polyimide-based shatterproof layer by a single coating, thereby simplifying a process step to reduce costs, and also may maintain the surface hardness properties of the glass substrate as they are by the effect described above.

Hereinabove, although the present disclosure has been described by specific matters, limited exemplary embodiments, and drawings, they have been provided only for assisting the entire understanding of the present disclosure, and the present disclosure is not limited to the exemplary embodiments, and various modifications and changes may be made by those skilled in the art to which the present disclosure pertains from the description.

Therefore, the spirit of the present disclosure should not be limited to the above-described exemplary embodiments, and the following claims as well as all modified equally or equivalently to the claims are intended to fall within the scope and spirit of the disclosure.

What is claimed is:

1. A glass substrate multilayer structure comprising:
a flexible glass substrate; and
a polyimide-based shatterproof layer formed on one surface of the flexible glass substrate.

2. The glass substrate multilayer structure of claim 1, wherein the polyimide-based shatterproof layer is formed of a polyimide-based resin comprising a unit derived from a fluorine-based aromatic diamine and a unit derived from an aromatic dianhydride.

3. The glass substrate multilayer structure of claim 1, wherein the flexible glass substrate has a thickness of 1 to 100 μm.

4. The glass substrate multilayer structure of claim 1, wherein the polyimide-based shatterproof layer has a thickness of 100 nm to 10 μm.

5. The glass substrate multilayer structure of claim 1, wherein the glass substrate multilayer structure has a pencil hardness of 4H to 6H in accordance with ASTM D3363.

6. The glass substrate multilayer structure of claim 1, wherein the glass substrate multilayer structure has an impact resistance of 20 cm or more by a pen drop test.

7. The glass substrate multilayer structure of claim 1, wherein the glass substrate multilayer structure has a value within ±0.2 mm in bending properties as measured after each of the shatterproof layer and a hard coating layer are formed on a glass substrate having a width of 180 mm×a length of 76 mm×a thickness of 40 μm and then immediately the glass substrate multilayer structure is placed on a leveled vibration isolation table, and adhesion of 5B in accordance with ASTM D3359.

8. A method of producing a glass substrate multilayer structure, the method comprising: applying a shatterproof composition on a rear surface of a flexible glass substrate and curing the shatterproof composition to form a polyimide-based shatterproof layer.

9. The method of producing a glass substrate multilayer structure of claim 8, wherein the shatterproof composition comprises a fluorine-based aromatic diamine and an aromatic dianhydride.

10. A flexible display panel comprising the glass substrate multilayer structure of claim 1.
